(19) United States
(12) Patent Application Publication
(10) Pub. No.: US 2026/0260313 A1
(43) Pub. Date: Sep. 3, 2026

(54) METHOD AND APPARATUS FOR DATA SCHEDULING BASED ON RAY TRACING, SYSTEM, DEVICE, STORAGE MEDIUM, AND COMPUTER PROGRAM PRODUCT

(71) Applicant: Moore THREADS TECHNOLOGY CO., LTD., Beijing (CN)

(72) Inventors: Lulu SONG, Beijing (CN); Jinge WANG, Beijing (CN); Jianbo XU, Beijing (CN)

(21) Appl. No.: 19/163,681

(22) PCT Filed: Mar. 14, 2024
(86) PCT No.: PCT/CN2024/081658

§ 371 Date: Sep. 9, 2025

(30) Foreign Application Priority Data
Mar. 30, 2023 (CN) 202310331358.1

(51) Int. Cl. G06T 1/60; G06T 15/06

(52) U.S. Cl. CPC G06T 1/60; G06T 15/06

(57) ABSTRACT

Embodiments of the present disclosure provide a method and apparatus for data scheduling based on ray tracing, a system, a device, a storage medium, and a computer program product. The method comprises: determining a first target storage block in a first memory and a target storage block group in a second memory, the first target storage block and the target storage block group respectively storing ray data and block data having a correspondence relationship; reading the ray data from the first target storage block; and reading the block data from the target storage block group in two scheduling cycles, said data read scheduling using write-priority mode in the first scheduling cycle and read-priority mode in the second scheduling cycle, respectively.

### CROSS-REFERENCE TO RELATED APPLICATION

The present application is based on and claims the priority to Chinese Patent Application No. 202310331358.1, filed on Mar. 30, 2023, and entitled “METHOD AND APPARATUS FOR DATA SCHEDULING BASED ON RAY TRACING, DEVICE, AND STORAGE MEDIUM”. The entire content of the Chinese Patent Application is incorporated herein by reference.

### TECHNICAL FIELD

The present disclosure relates to, but is not limited to, the field of information technology, in particular to a method, a device and a system for data scheduling based on ray tracing, a device, a storage medium and a computer program product.

### BACKGROUND

In ray tracing processing, ray data of a ray and block data of an object block (such as a BOX, or a Triangle, etc.) are sent to the Arithmetic and Logic unit (ALU) for intersection operation of the ray and the object block only after both the ray data and the block data are obtained. However, in the related art, data reading should be delayed for a period of time due to a read-write conflict of a memory block in a memory, which affects the efficiency of data reading.

### SUMMARY

The embodiments of the present disclosure provide a method, a device, and a system for data scheduling based on ray tracing, a device, a storage medium, and a computer program product, which can improve read scheduling efficiency of block data, and improve the operation efficiency of subsequent operations based on ray data and block data.

The technical solution of the embodiment of the present disclosure is implemented as follows.

An embodiment of the present disclosure provides a method for data scheduling based on ray tracing, and the method includes the following operations.

A first target memory block in a first memory and a target memory block group in a second memory are determined. Ray data and block data which have a correspondence relationship are stored respectively in the first target memory block and the target memory block group.

The ray data is read from the first target memory block.

The block data is read from the target memory block group in two scheduling cycles. A write-priority mode and a read-priority mode are respectively used to perform data read scheduling in the first scheduling cycle and the second scheduling cycle of the two scheduling cycles.

An embodiment of the present disclosure provides a device for data scheduling based on ray tracing, and the device includes a first determining portion, a first reading portion and a second reading portion.

The first determining portion is configured to determine a first target memory block in a first memory and a target memory block group in a second memory. Ray data and block data which have a correspondence relationship are stored respectively in the first target memory block and the target memory block group.

The first reading portion is configured to read the ray data from the first target memory block.

The second reading portion is configured to read the block data from the target memory block group in two scheduling cycles. A write-priority mode and a read-priority mode are respectively used to perform data read scheduling in the first scheduling cycle and the second scheduling cycle of the two scheduling cycles.

An embodiment of the present disclosure provides a system for data scheduling based on ray tracing, and the system includes a first memory, a second memory and a scheduler.

The first memory is used for storing ray data.

The second memory is used for storing block data.

The scheduler is communicatively connected to the first memory and the second memory, and is configured to perform a part or all of the operations of the method.

An embodiment of the present disclosure provides a computer device including a processor and a memory for storing a computer program which is able to run on the processor. The program, when executed by the processor, implements a part or all of the operations in the above-described method.

An embodiment of the present disclosure provides a computer-readable storage medium on which a computer program is stored. The computer program is executed by a processor to implement a part or all of the operations of the above-described method.

An embodiment of the present disclosure provides a computer program product including a computer program or instruction that, when executed by a processor, implements a part or all of the operations of the above method.

In an embodiment of the present disclosure, a first target memory block in a first memory and a target memory block group in a second memory are determined, and ray data and block data which have a correspondence relationship are stored respectively in the first target memory block and the target memory block group. The ray data is read from the first target memory block, and the block data is read from the target memory block group in two scheduling cycles. A write-priority mode and a read-priority mode are respectively used to perform data read scheduling in the first scheduling cycle and the second scheduling cycle of the two scheduling cycles. In this way, the block data can be read in two parts. On the one hand, the data read scheduling is performed in the write-priority mode in the first scheduling cycle, to ensure that the priority of writing data in the target memory block group is high as possible. On the other hand, the data read scheduling is performed in the read-priority mode in the second scheduling cycle, to ensure that the complete block data can be read from the target memory block group in at most two scheduling cycles. In this way, the read and write priority of the data read scheduling in the two scheduling cycles is adjusted dynamically. Therefore, both the reading and writing requirements of the data in the target memory block group can be taken into account, thereby improving the read scheduling efficiency of the block data, and improving the operation efficiency of subsequent operations based on the ray data and the block data.

It should be understood that the above general description and the following detailed description are exemplary and explanatory only, and do not limit the present disclosure.

### BRIEF DESCRIPTION OF THE DRAWINGS

The accompanying drawings herein are incorporated into and constitute a part of the specification, illustrate embodiments consistent with the present disclosure, and together with the specification, are used to explain technical solutions of the present disclosure.

FIG. 1A is a first schematic flowchart of an implementation of a method for data scheduling based on ray tracing according to an embodiment of the present disclosure.

FIG. 1B is a schematic diagram of an implementation of reading ray data and block data in a method for data scheduling based on ray tracing according to an embodiment of the present disclosure.

FIG. 2A is a second schematic flowchart of an implementation of a method for data scheduling based on ray tracing according to an embodiment of the present disclosure.

FIG. 2B is a schematic flowchart of an implementation of determining a first target memory block and a target memory block group according to an embodiment of the present disclosure.

FIG. 3A is a first schematic diagram of a composition structure of a system for data scheduling based on ray tracing according to an embodiment of the present disclosure.

FIG. 3B is a second schematic diagram of a composition structure of a system for data scheduling based on ray tracing according to an embodiment of the present disclosure.

FIG. 4 is a schematic diagram of a composition structure of a device for data scheduling based on ray tracing according to an embodiment of the present disclosure.

FIG. 5 is a schematic diagram of a hardware entity of a computer device according to an embodiment of the present disclosure.

### DETAILED DESCRIPTION

In order to make the object, technical solution, and advantages of the present disclosure clearer, the technical solution of the present disclosure is described in further detail below with reference to the accompanying drawings and embodiments. The described embodiments are not regarded as a limit to the present disclosure. All other embodiments obtained by those skilled in the art without creative work fall within the scope of protection of the present disclosure.

In the following description, the expression “some embodiments” describes a subset of all possible embodiments, but it is understood that the expression “some embodiments” may be the same subset or different subsets of all possible embodiments, and may be combined with each other without conflict.

In the following description, the terms “first/second/third” are merely to distinguish similar objects and does not represent a specific order of the objects, and it is understood that “first/second/third” may be interchanged in a specific order or a priority order, so that the embodiments of the present disclosure described herein can be implemented in an order other than that illustrated or described herein.

Unless otherwise defined, all technical and scientific terms used herein have the same meaning as commonly understood by those skilled in the art belonging to the present disclosure. The terms used herein are for the purpose of describing the disclosure, rather than limiting the disclosure.

In order to better understand the method for data scheduling based on ray tracing provided by the embodiment of the present disclosure, a solution for data scheduling in the related art is described below.

In the ray tracing process, ray data of the ray and block data of the object block are sent to the Arithmetic and Logic unit (ALU) for intersection operation only after both the ray data and the block data are obtained. In the related art, a structure of a double data rate (DDR) synchronous dynamic random access memory (RAM) and a Cache is generally used for storing block data. Generally, the Cache is a single-port RAM, and the write operation has a high priority absolutely. When there is a data writing request, the read scheduling should be suspended, thereby affecting the read scheduling efficiency of block data, and affecting the utilization rate of the arithmetic unit.

On this basis, the embodiments of the present disclosure provide a method for data scheduling based on ray tracing, and the method may be applied to a scheduler of a processor. The processor may include, for example, but is not limited to, at least one of a central processing unit (CPU), a graphics processing unit (GPU), or the like.

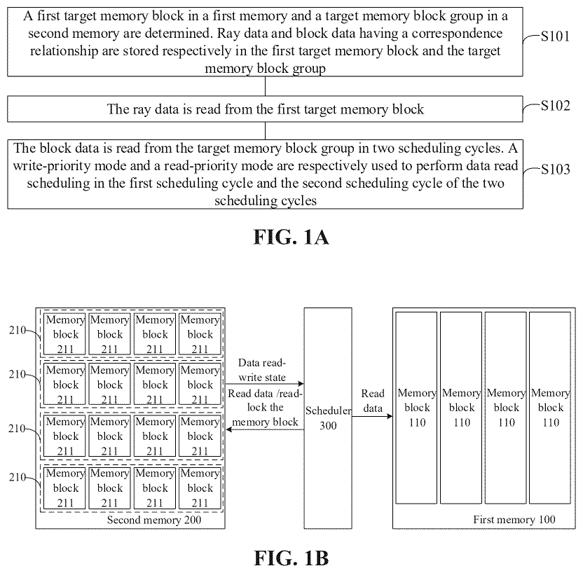

FIG. 1A is a first schematic flowchart of an implementation of a method for data scheduling based on ray tracing according to an embodiment of the present disclosure. As shown in FIG. 1A, the method may include the following operations S101 to S103.

At operation S101, a first target memory block in a first memory and a target memory block group in a second memory are determined. Ray data and block data which have a correspondence relationship are stored respectively in the first target memory block and the target memory block group.

Here, each of the first memory and the second memory may be any suitable memory determined according to the actual situation, for example, including but not limited to at least one of a Cache, a Buffer, and the like. In some implementations, the first memory may be a Buffer for storing ray data, and the second memory may be a Cache for storing block data.

The first memory may include a plurality of memory blocks. The second memory may include a plurality of memory block groups, and each memory block group includes a plurality of memory blocks. Ray data may be written into at least one memory block of the first memory by a write operation, and block data may be written into a memory block in at least one memory block group of the second memory by a write operation. In some embodiments, each address in the first memory may correspond to at least one memory block, each address in the second memory may correspond to at least one memory block in a memory block group, one memory block of the first memory may store one ray data, and at least one memory block corresponding to one address in the memory block group of the second memory may collectively store a complete block data.

In implementation, data stored in each memory block of the first memory and data stored in each memory block group of the second memory may be prefetched respectively, to detect whether the first memory and the second memory respectively have a first target memory block and a target memory block group which respectively store ray data and block data that have a correspondence relationship. After the first target memory block of the first memory and the target memory block group of the second memory are determined, the ray data and block data have a correspondence relationship are read respectively from the first target memory block and the target memory block group. For example, the ray data and the block data have a correspondence relationship may be a pair of ray data and block data to which the intersection operation is performed, and whether a ray corresponding to the ray data intersects with an object block corresponding to the block data may be determined by performing the intersection operation on the pair of ray data and the block data.

At operation S102, the ray data is read from the first target memory block.

Here, data read scheduling may be performed after the first target memory block is determined, to read ray data from the first target memory block.

In implementation, the read scheduling may be performed on the first target memory block in any suitable manner to read the ray data in the first target memory block, which is not limited in the embodiments of the present disclosure. For example, the read scheduling may be performed on the first target memory block in a read-priority mode or a write-priority mode to read the ray data in the first target memory block.

In some embodiments, the ray data may be read from the first target memory block into a scheduler, and the scheduler may transmit the read ray data to other units (such as the arithmetic unit). In some embodiments, the scheduler may send a read scheduling instruction to the first memory, so that the first memory transmits the ray data stored in the first target memory block to other units (such as the arithmetic unit).

At step S103, the block data is read from the target memory block group in two scheduling cycles. A write-priority mode and a read-priority mode are respectively used to perform data read scheduling in the first scheduling cycle and the second scheduling cycle of the two scheduling cycles.

Here, data read scheduling may be performed in the write-priority mode in the first scheduling cycle and then data read scheduling may be performed in the read-priority mode in the second scheduling cycle, to read block data from a target memory block group in two parts.

It can be understood that the data read scheduling being performed in a write-priority mode in the first scheduling cycle means that the data writing operation has the highest priority in the first scheduling cycle, and if there is a requirement of data writing for at least one memory block in the target memory block group in the first scheduling cycle, the requirement of data writing in the at least one memory block is preferentially met, and only data in other memory blocks other than the at least one memory block can be read in the first scheduling cycle. The data read scheduling being performed in a read-priority mode in the second scheduling cycle means that the data reading operation has the highest priority in the second scheduling cycle, and if the data in at least one memory block of the target memory block group is not read in the first scheduling cycle, the requirement of data reading in the at least one memory block is preferentially met in the second scheduling cycle, so that complete block data can be read from the target memory block group in at most two scheduling cycles.

FIG. 1B is a schematic diagram of an implementation of reading ray data and block data in a method for data scheduling based on ray tracing according to an embodiment of the present disclosure. As shown in FIG. 1B, the first memory 100 for storing ray data includes a plurality of memory blocks 110, and the second memory 200 for storing block data includes a plurality of memory block groups 210, each of which includes a plurality of memory blocks 211. The scheduler 300 may determine a first target memory block from the first memory 100 and determine the target memory block group from the second memory 200. Ray data and block data which have a correspondence relationship are stored respectively in the first target memory block and the target memory block group. After the first target memory block and the target memory block group are determined, the scheduler 300 may read the ray data from the first target memory block, and read the block data from the target memory block group in two scheduling cycles. A write-priority mode and a read-priority mode are respectively used to perform data read scheduling in the first scheduling cycle and the second scheduling cycle of the two scheduling cycles. After the ray data and the block data are read, the scheduler 300 may transmit the ray data and the block data to an arithmetic unit to perform an intersection operation to obtain an intersection state between the ray corresponding to the ray data and the target block corresponding to the block data.

In some embodiments, the ray data may be stored within a first target address of the first target memory block, and the block data may be stored within a second target address of the target memory block group. In implementation, the ray data may be read from the first target address of a first target memory block, and the block data may be read from the second target address of the target memory block group in two scheduling cycles.

In an embodiment of the present disclosure, a first target memory block in a first memory and a target memory block group in a second memory are determined, and ray data and block data which have a correspondence relationship are stored respectively in the first target memory block and the target memory block group. The ray data is read from the first target memory block, and the block data is read from the target memory block group in two scheduling cycles. A write-priority mode and a read-priority mode are respectively used to perform data read scheduling in the first scheduling cycle and the second scheduling cycle of the two scheduling cycles. In this way, the block data can be read in two parts. On the one hand, the data read scheduling is performed in the write-priority mode in the first scheduling cycle, to ensure that the priority of writing data in the target memory block group is high as possible. On the other hand, the data read scheduling is performed in the read-priority mode in the second scheduling cycle, to ensure that the complete block data can be read from the target memory block group in at most two scheduling cycles. In this way, the read and write priority of the data read scheduling in the two scheduling cycles is adjusted dynamically. Therefore, both the read and write requirements of the data in the target memory block group can be taken into account, thereby improving the read scheduling efficiency of the block data, and improving the operation efficiency of subsequent operations based on the ray data and the block data.

In some embodiments, the block data is stored in a second target address of the target memory block group, the second target address corresponds to a plurality of memory blocks in the target memory block group, and the block data includes at least one of first sub-data and second sub-data. The above operation S103 may include the following operations S111 to S112.

At step S111, within the first scheduling cycle, in a case where there is at least one second target memory block, to which no data is being written, among a plurality of memory blocks corresponding to the second target address, the first sub-data is read from the at least one second target memory block.

At step S112, within the second scheduling cycle, in a case where there is at least one third target memory block, other than the second target memory block, among the plurality of memory blocks corresponding to the second target address, the at least one third target memory block is read-locked and the second sub-data is read from the at least one third target memory block.

Here, the number of second target memory blocks and the number of third target memory blocks among the plurality of memory blocks corresponding to the second target address may be determined according to the actual situation.

For example, in the first scheduling cycle, if no data is written to all of the memory blocks corresponding to the second target address of the target memory block group, all of the memory blocks corresponding to the second target address in the target memory block group are the second target memory blocks, and the first sub-data can be read from each of the second target memory blocks in the first scheduling cycle. In the second scheduling cycle, since all of the memory blocks corresponding to the second target address in the target memory block group are the second target memory blocks, that is, there is no third target memory block in the memory blocks corresponding to the second target address, it is not necessary to continue data read scheduling in the memory blocks corresponding to the second target address in the target memory block group in the second scheduling cycle. In this way, the read block data includes only the first sub-data, that is, the complete block data can be read in the first scheduling cycle.

For another example, in the first scheduling cycle, if data is being written to at least one memory block of all of the memory blocks corresponding to the second target address in the target memory block group, a memory block to which no data is being written among all of the memory blocks corresponding to the second target address in the target memory block group is determined as the second target memory block, and the first sub-data can be read from each second target memory block in the first scheduling cycle. In the second scheduling cycle, the memory block other than the second target memory block among all of the memory blocks corresponding to the second target address in the target memory block group may be determined as a third target memory block, that is, the memory block to which data is written in the first scheduling cycle may be determined as a third target memory block, and the second sub-data may be read from the third target memory block in the second scheduling cycle. In this way, the read block data includes the first sub-data and the second sub-data, that is, the complete block data is read in the first scheduling cycle and the second scheduling cycle.

For another example, in the first scheduling cycle, if data is written to each of the memory blocks corresponding to the second target address in the target memory block group, and there is no second target memory block among the memory blocks corresponding to the second target address in the target memory block group, data read scheduling cannot be performed in the target memory block group in the first scheduling cycle, that is, the first sub-data cannot be read. In the second scheduling cycle, since there is no second target memory block among the memory blocks corresponding to the second target address in the target memory block group, that is, all of the memory blocks corresponding to the second target address are third target memory blocks, the second sub-data can be read from each of the third target memory blocks in the second scheduling cycle. In this way, the read block data includes only the second sub-data, that is, the complete block data can be read in the second scheduling cycle.

It can be understood that after the second sub-data is read from the third target memory block, the read-lock of the third target memory block may be released, and the third target memory block is in a read-unlocked state after the read lock is released.

In an embodiment of the present disclosure, in a first scheduling cycle, in case where there is at least one second target memory block to which no data is being written among a plurality of memory blocks corresponding to the second target address, the first sub-data is read from the at least one second target memory block. In the second scheduling cycle, in case where there is at least one third target memory block other than the second target memory block among the plurality of memory blocks corresponding to the second target address, the at least one third target memory block is read-locked and the second sub-data is read from the at least one third target memory block. In this way, the complete block data can be easily and quickly read from the target memory block group in at most two scheduling cycles.

In some embodiments, the above operation S103 may further include the following operation S121.

At operation S121, in the second scheduling cycle, in a case where there is a fourth target memory block having a data writing request in the target memory block group and the fourth target memory block is not read-locked, data is written to the fourth target memory block.

Here, the scheduler performs data read scheduling in a read-priority mode in the second scheduling cycle, and whether the fourth target memory block is read-locked may be determined if the fourth target memory block has a data writing request. If the fourth target memory block is not read-locked, data can be written to the fourth target memory block. If the fourth target memory block is read-locked, data cannot be written to the fourth target memory block in the second scheduling cycle, and data writing waits until the next scheduling cycle.

In implementation, the fourth target memory block may be any suitable memory block in the target memory block group, which is not limited in the embodiment of the present disclosure. For example, the fourth target memory block may be the second target memory block to which no data is being written in a first scheduling cycle, That is, data can be read from the fourth target memory block in the first scheduling cycle, and the fourth target memory block is not read-locked in the second scheduling cycle. In this case, in the second scheduling cycle, when the fourth target memory block has a data writing request, data can be written to the fourth target memory block because the fourth target memory block is not read-locked. For another example, the fourth target memory block may be the third target memory block other than the second target memory block among the plurality of memory blocks corresponding to the second target address, and the fourth target memory block may be read-locked in the second scheduling cycle. In this case, in the second scheduling cycle, when the fourth target memory block has a data writing request, data cannot be written to the fourth target memory block because the fourth target memory block is read-locked.

In the above-described embodiment, in the second scheduling cycle, in case where a fourth target memory block in the target memory block group has a data writing request and the fourth target memory block is not read-locked, data is written to the fourth target memory block. In this way, the data writing in the target memory block group can be kept as high priority as possible, so as to take both the reading requirement and writing requirement of the data in the target memory block group into account.

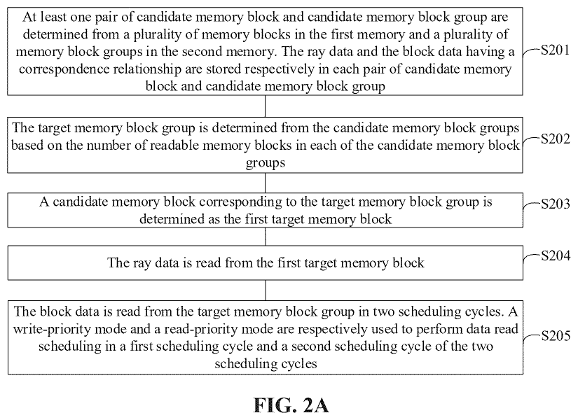

The embodiments of the present disclosure provide a method for data scheduling based on ray tracing, and the method may be applied to a scheduler of a processor. FIG. 2A is a second schematic flowchart of an implementation of a method for data scheduling based on ray tracing according to an embodiment of the present disclosure. As shown in FIG. 2A, the method may include the following operations S201 to S205.

At operation S201, at least one pair of candidate memory block and candidate memory block group are determined from a plurality of memory blocks in the first memory and a plurality of memory block groups in the second memory. The ray data and the block data having a correspondence relationship are stored respectively in each pair of candidate memory block and candidate memory block group.

Here, data stored in each memory block in the first memory and data stored in each memory block group in the second memory may be prefetched, and in case that the block data prefetched from a memory block group in the second memory has a correspondence relationship with the ray data prefetched from a memory block in the first memory, it is determined that the memory block in the first memory and the memory block group in the second memory respectively store the ray data and the block data which have a correspondence relationship, and the memory block and the memory block group may be determined as a pair of candidate memory block and candidate memory block group.

In some embodiments, in case where it is determined that the memory block of the first memory and the memory block group of the second memory respectively store the ray data and the block data which have a correspondence relationship, and the memory block of the first memory is not occupied by another operation, the memory block and the memory block group may be determined as a pair of candidate memory block and candidate memory block group.

At step S202, the target memory block group is determined from the candidate memory block groups based on the number of readable memory blocks in each of the candidate memory block groups.

Here, the readable memory block is a memory block in a readable state. In implementation, whether each memory block in the candidate memory block group is in a readable state, that is, whether each memory block is a readable memory block, may be determined by acquiring a read-write state of the memory block, and further the number of readable memory blocks in the candidate memory block group is determined.

In some embodiments, one candidate memory block group including the largest number of readable memory blocks among the candidate memory block groups may be determined as a target memory block group.

In some embodiments, one candidate memory block group may be randomly selected from multiple candidate memory block groups including the largest number of readable memory blocks in the candidate memory block groups and determined as the target memory block group.

At operation S203, a candidate memory block corresponding to the target memory block group is determined as the first target memory block.

Here, the candidate memory block corresponding to the target memory block group may be a candidate memory block belonging to the same pair of candidate memory block and candidate memory block group as the target memory block group.

In some embodiments, the target memory block group may correspond to one candidate memory block, and the candidate memory block may be determined as the first target memory block.

In some embodiments, the target memory block group may correspond to at least two candidate memory blocks, and one candidate memory block can be selected in any suitable selection rule from the at least two candidate memory blocks, as the first target memory block. For example, the candidate memory block having the smallest identifier among the at least two candidate memory blocks may be determined as the first target memory block. As another example, one candidate memory block may be randomly determined from at least two candidate memory blocks as the first target memory block.

At operation S204, ray data is read from the first target memory block.

At operation S205, block data is read from the target memory block group in two scheduling cycles. A write-priority mode and a read-priority mode are respectively used to perform data read scheduling in the first scheduling cycle and the second scheduling cycle of the two scheduling cycles.

Here, operations S204 to S205 correspond to operations S102 to S103 in the foregoing embodiment, respectively, and can be implemented with reference to the embodiments of operations S102 to S103.

In an embodiment of the present disclosure, at least one pair of candidate memory block and candidate memory block group are determined from a plurality of memory blocks in the first memory and a plurality of memory block groups in the second memory. The ray data and the block data which have a correspondence relationship are stored respectively in each pair of candidate memory block and candidate memory block group. The target memory block group is determined from the candidate memory block groups based on the number of readable memory blocks in each of the candidate memory block groups. A candidate memory block corresponding to the target memory block group is determined as a first target memory block. In this way, the number of readable memory blocks in the candidate memory block groups is considered in the process of determining the target memory block group and the first target memory block. Therefore, the target memory block group and the first target memory block can be determined in a suitable manner.

In some embodiments, the operation S202 may include operations S211 to S212 as follows.

At operation S211, the number of readable memory blocks in each of the candidate memory block groups is determined.

A read-write state of the readable memory block is a readable state.

At operation S212, a memory block group having the largest number of readable memory blocks in the candidate memory block groups is determined as the target memory block group.

In this way, since the target memory block group is the memory block group having the largest number of readable memory blocks in the candidate memory block groups, more second target memory blocks can be determined in the first scheduling cycle, and the number of third target memory blocks which is to be read-locked in the second scheduling cycle is smaller. Thus, the read-write conflict of the data in the process of reading the block data can be further reduced, and both the data read requirement and the data read write requirement in the target memory block group can be taken into account.

In some embodiments, in case where the candidate memory block groups include multiple memory block groups having the largest number of readable memory blocks, one memory block group may be selected according to a preset selection manner from the multiple memory block groups having the largest number of readable memory blocks, as the target memory block group.

In some embodiments, in case where the candidate memory block groups include only one memory block group having the largest number of readable memory blocks, the memory block group having the largest number of readable memory blocks may be determined as the target memory block group.

In some embodiments, operation S211 may include operation S221 as follows.

At operation S221, for each of the candidate memory block groups, the read-write state of each memory block in the candidate memory block group is determined, and the memory blocks, the read-write state of which is the readable state, in the candidate memory block group are counted up, to obtain the number of readable memory blocks in the candidate memory block group.

Here, the read-write state of the memory block may include a readable state or an unreadable state. The number of readable memory blocks in the candidate memory block group may be determined by counting up the number of memory blocks in the readable state in the candidate memory block group.

In some embodiments, the above method may further include the following operations S231 to S232.

At step S231, a write-lock state and a read-lock state of each memory block in the candidate memory block group are acquired.

The write-lock state includes one of a first state characterizing that data is being written to the memory block, and a second state characterizing that no data is being written to the memory block, and the read-lock state comprises one of a third state characterizing that the memory block is read-locked, and a fourth state characterizing that the memory block is not read-locked.

Here, the write-lock state of the memory block may characterize whether the memory block is write-locked, that is, whether the memory block is locked by another data write operation. The read-lock state of the memory block may indicate whether the memory block is read-locked, i.e. whether the memory block is locked by another data read operation.

In some embodiments, in case where the memory block is locked by another data read operation, the read-lock state of the memory block may be determined to be the third state. In case where the memory block is not locked by another data read operation, the read-lock state of the memory block may be determined to be the fourth state.

In some implementations, another data read operation which read-locks the memory block may be an operation that reads data from the memory block by read-locking the memory block before the current scheduling cycle. After another data read operation have completed reading data from the memory block, the read-lock of the memory block can be released, and the memory block is in a read-unlocked state after the read-lock is released. For example, if another data read operation read-locks the memory block before the current scheduling cycle, but do not complete reading data in the memory block until the current scheduling cycle, the read-lock of the memory block will not be released, that is, the memory block is still be read-locked, and the read-lock state of the memory block in the current scheduling cycle is the third state characterizing that the memory block is read-locked. For another example, if another data read operation read-locks the memory block before the current scheduling cycle, but has completed reading data in the memory block before entering the current scheduling cycle, the read-lock of the memory block is released before the current scheduling cycle, and the read-lock state of the memory block in the current scheduling cycle is the fourth state characterizing that the memory block is not read-locked.

During implementation, those skilled in the art can determine the write-lock state and the read-lock state of each memory block in any suitable manner according to the actual situation, which is not limited in the embodiments of the present disclosure.

In some embodiments, two pieces of state information including a write-lock state and a read-lock state may be set for each memory block. When data is being written to the memory block, the write-lock state corresponding to the memory block may be set to be the first state. When no data is being written to the memory block, the write-lock state corresponding to the memory block may be set to be the second state. When the memory block is read-locked, the read-lock state corresponding to the memory block may be set to be the third state. When the memory block is not read-locked, the read-lock state corresponding to the memory block may be set to be the fourth state.

In some embodiments, the read-lock state and the write-lock state corresponding to each memory block may be stored in a register, and the scheduler may determine the read-lock state and the write-lock state corresponding to the memory block by reading a value in the register. During implementation, the read-lock state and the write-lock state may be stored in the same register or different registers, which is not limited in the embodiments of the present disclosure.

In some embodiments, the scheduler may request the second memory to search for the write-lock state and the read-lock state of each memory block through an interface, and the second memory may transmit the write-lock state and the read-lock state of each memory block to the scheduler upon receiving the request for searching for the write-lock state and the read-lock state from the scheduler.

At operation S232, in case where the write-lock state of the memory block is the second state and the read-lock state of the memory block is the fourth state, the read-write state of the memory block is determined to be the readable state.

In the above embodiment, the write-lock state and the read-lock state of each memory block in the candidate memory block group are acquired, and for each memory block in the candidate memory block group, in case where the write-lock state of the memory block is a write-unlocked state and the read-lock state of the memory block is a read-unlocked state, the read-write state of the memory block is determined to be the readable state. In this way, the readable memory block in the candidate memory block group can be simply and efficiently determined.

In some embodiments, the above operation S202 may include operations S241 to S242 as follows.

At operation S241, a first memory block group having the largest number of readable memory blocks among the candidate memory block groups is determined.

At operation S242, in case where there are multiple first memory block groups, one first memory block group is selected according to a preset selection manner from the multiple first memory block groups, as the target memory block group.

Here, the preset selection manner may be set in advance by the user, which is not limited in the embodiment of the present disclosure. For example, one first memory block group may be randomly selected as the target memory block group in a random selection manner from the multiple first memory block groups. For another example, a first memory block group having the smallest group identifier may be selected as the target memory block group from the first memory block groups.

In some embodiments, in case where the candidate memory block groups have the same number of readable memory blocks, all the candidate memory block groups are the first memory block groups, and one candidate memory block group is selected according to a preset selection manner from the candidate memory block groups, as the target memory block group.

In some embodiments, when the candidate memory block groups have different numbers of readable memory blocks, the candidate memory block group having the largest number of readable memory blocks in the candidate memory block groups may be determined as the first memory block group. When there are multiple first memory block groups, one first memory block group is selected in a preset selection manner from the multiple first memory block groups, as the target memory block group. When there is only one the first memory block group, the first memory block group is determined as the target memory block group.

In some embodiments, the above operation S201 may include the following operation S251.

At operation S251, at least one pair of candidate memory block and candidate memory block group, a first target address corresponding to the candidate memory block and a second target address corresponding to the candidate memory block group in each pair of candidate memory block and candidate memory block group are determined from the plurality of memory blocks in the first memory and the plurality of memory block groups in the second memory. In each pair of candidate memory block and candidate memory block group, the ray data and the block data which have a correspondence relationship are stored respectively in the first target address of the candidate memory block and the second target address of the candidate memory block group.

Here, data stored in each memory block in the first memory and data stored in each memory block group in the second memory may be prefetched, and in case that the block data prefetched from the memory block group in the second memory has a correspondence relationship with the ray data prefetched from the memory block in the first memory, it is determined that the memory block in the first memory and the memory block group in the second memory respectively store the ray data and the block data which have a correspondence relationship, and the memory block and the memory block group may be determined as a pair of candidate memory block and candidate memory block group, and the address in the memory block where the ray data is stored is determined as the first target address corresponding to the candidate memory block, the addresses of the multiple memory blocks in the memory block group where the block data is stored are determined as the second target address corresponding to the candidate memory block group.

In some embodiments, the respective addresses of the memory block and the memory block group from which the first pair of ray data and block data having a correspondence relationship are prefetched may be determined as a first target address of the candidate memory block corresponding to the ray data and a second target address of the candidate memory block group corresponding to the block data, respectively.

In some embodiments, among multiple pairs of ray data and block data having a correspondence relationship prefetched from the memory block and the memory block group, the addresses of the memory block and the memory block group where the first pair of ray data and block data is stored are located may be determined as the first target address of the candidate memory block corresponding to the ray data and the second target address of the candidate memory block group corresponding to the block data, respectively.

In some embodiments, the above operation S201 may include operations S261 to S262 as follows.

At operation S261, whether each pair of memory block and memory block group determined from the multiple memory blocks in the first memory and the multiple memory block groups in the second memory respectively store ray data and block data having a correspondence relationship is detected.

At operation S262, for each pair of memory block and memory block group where the ray data and the block data having a correspondence relationship are stored respectively, the memory block and the memory block group are determined as a pair of candidate memory block and candidate memory block group when the read-write state of the memory block is a readable state.

Here, the pair of candidate memory block and candidate memory block group may be a memory block and a memory block group where the ray data and the block data having a correspondence relationship are stored respectively, and the read-write state of the candidate memory block is a readable state.

In this way, the determined first target memory block is in a readable state, so that the ray data can be read from the first target memory block without waiting caused by a read and write conflict with other operation, thereby further improving the efficiency of read scheduling of the ray data, and further improving the utilization rate of the arithmetic unit and the arithmetic efficiency of the intersection operation.

In some embodiments, for each pair of candidate memory block and candidate memory block group, ray data and block data having a correspondence relationship are stored respectively in a first target address of the candidate memory block and a second target address of the candidate memory block group. The above operation S202 may include determining the target memory block group from the candidate memory block groups based on the number of readable memory blocks in multiple memory blocks corresponding to the first target address in each of the candidate memory block groups.

In some embodiments, a memory block group having the largest number of readable memory blocks in the plurality of memory blocks corresponding to the first target address among the candidate memory block groups may be determined as the target memory block group.

FIG. 2B is a schematic flowchart of an implementation of determining a first target memory block and a target memory block group according to an embodiment of the present disclosure. As shown in FIG. 2B, it is assumed that the first memory includes four memory blocks rbank0, rbank1, rbank2, and rbank3, and the second memory includes 16 memory blocks nbank0 to nbank15, which are located respectively in four memory block groups group0, group1, group2, and group3. The write-lock state wr_bank_status[15:0] and the read-lock state lock_bank[15:0] of the memory blocks nbank15 to nbank0 in the second memory may be obtained. A mask operation is performed on the write-lock state wr_bank_status[15:0] and the read-lock state lock_bank[15:0] of the memory blocks nbank15 to nbank0 to obtain idle state idle_bank[15:0] (i.e. the read-write state) of the memory blocks nbank15 to nbank0, idle_bank[15:0]=(wr_bank_status[15:0]|| lock_bank[15:0]). The number sum0 to sum3 of idle memory blocks (that is, readable memory blocks) in the memory block groups group0, group1, group2, and group3 are counted by groups according to the idle state idle_bank[15:0] of the memory blocks nbank15 to nbank0, and the memory block group having the largest number of idle memory blocks is determined as the target memory block group sel_group. Further, for 16 pairs of memory blocks and memory block groups composed of 4 memory blocks in the first memory and 4 memory block groups in the second memory, whether ray data and block data having a correspondence relationship are stored respectively in the memory block and the memory block group of each pair may be determined by data prefetching, which are denoted as tri_valid[15:0]. If the ray data and the block data having a correspondence relationship are stored respectively in a pair of memory block and memory block group, a value of a data bit corresponding to the pair of memory block and memory block group in tri_valid[15:0] is 0, otherwise, the value is 1. The read-write states rtram_rts_use[3:0] (that is, whether the memory block is occupied by another operation) corresponding to the four memory blocks rbank3 to rbank0 in the first memory can also be obtained. If the memory block is not occupied by another operation, a value of a data bit corresponding to the memory block in rtram_rts_use [3:0] is 0, otherwise, the value is 1. For each memory block among the memory blocks rbank3 to rbank0, a mask operation may be performed on 4-bit data corresponding to the memory block in tri_valid[15:0] indicating whether each pair of four pairs of memory blocks and memory block groups including the memory block store ray data and block data having a correspondence relationship, and 1-bit data corresponding to the memory block in rtram_rts_use[3:0] indicating the read-write state corresponding to the memory block, to obtain selection states sel[3:0]/sel[7:4]/sel[11:8]/sel[15:12] (that is, whether the pair of memory block and memory block group is in a selectable scheduling state, and if the pair of memory block and memory block group is in a selectable scheduling state, the value of the data bit corresponding to the pair of memory block and memory block group in sel[3:0]/sel[7:4]/sel[11:8]/sel[15:12] is 1, otherwise, the value is 0) respectively corresponding to the four pairs of memory blocks and memory block groups. For each memory block, selection states sel[12/8/4/0]/sel[13/9/5/1]/sel[14/10/8/2]/sel[15/11/7/3] respectively corresponding to the four pairs of memory blocks and memory block groups for each memory block group may be determined according to the selection states sel[3:0]/sel[7:4]/sel[11:8]/sel[15:12] respectively corresponding to the four pairs of memory blocks and memory block groups including the memory block. For each memory block group, the first pair among four pairs of memory blocks and memory block groups including the memory block group which is in a selectable scheduling state may be determined as a pair of candidate memory block and candidate memory block group. That is, regarding a data bit (that is, the first data bit with a value of 1) which is first assigned 1 among the selection states sel[12/8/4/0]/sel[13/9/5/1]/sel[14/10/8/2]/sel[15/11/7/3] respectively corresponding to the four pairs of memory blocks and memory block groups including the memory block group, the pair of memory block and memory block group corresponding to the data bit is a pair of candidate memory block and candidate memory block group. Finally, a first target memory block sel_bank corresponding to the target memory block group sel_group is selected from all pairs of candidate memory blocks and candidate memory block groups by using a data selector MUX according to the target memory block group sel_group. It is noted that, in the process of determining the target memory block group sel_group, the number of idle memory blocks is counted up only in the memory block group in each pair of memory block and memory block group in a selectable scheduling state, to reduce the amount of operation.

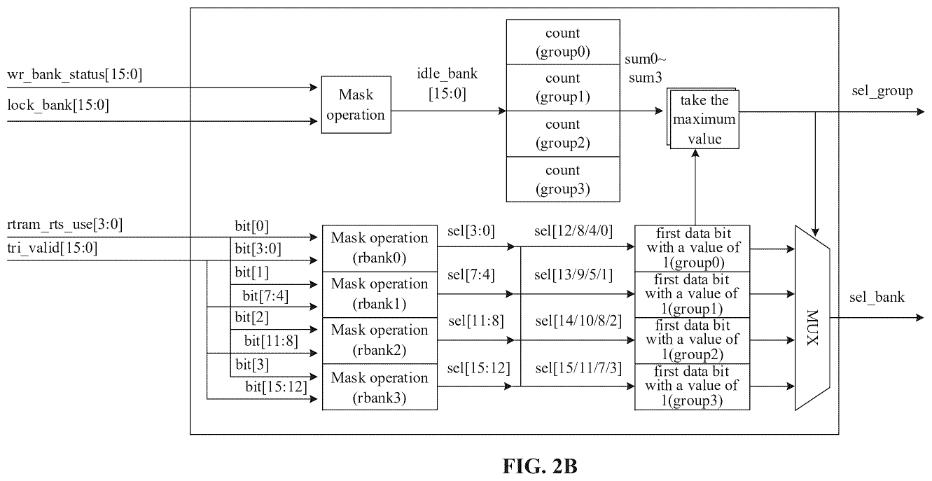

The embodiment of the present disclosure provides a system for data scheduling based on ray tracing. FIG. 3A is a first schematic diagram of a composition structure of a system for data scheduling based on ray tracing according to an embodiment of the present disclosure. As shown in FIG. 3A, the system includes a first memory 100, a second memory 200 and a scheduler 300.

The first memory 100 is configured for storing ray data.

The second memory 200 is configured for storing block data.

The scheduler 300 is communicatively connected to the first memory 100 and the second memory 200, and is configured to perform the method for data scheduling based on ray tracing described in the above embodiment.

In some embodiments, the scheduler 300 is configured to determine a first target memory block in the first memory 100 and a target memory block group in the second memory 200. The first target memory block and the target memory block group respectively store ray data and block data having a correspondence relationship. The scheduler 300 is configured to read the ray data from the first target memory block, and read the block data from the target memory block group in two scheduling cycles. A write-priority mode and a read-priority mode are respectively used to perform data read scheduling in the first scheduling cycle and the second scheduling cycle of the two scheduling cycles.

In some embodiments, FIG. 3B is a second schematic diagram of a composition structure of a system for data scheduling based on ray tracing according to an embodiment of the present disclosure. As shown in FIG. 3B, the system may further include an arithmetic unit 400 that is communicatively connected to the first memory 100 and the second memory 200, and is configured to respectively receive ray data and block data from the first memory 100 and the second memory 200 for an intersection operation. The scheduler 300 is further configured to read ray data from the first target memory block into the arithmetic unit 400; and read block data from the target memory block group into the arithmetic unit 400 in two scheduling cycles, to cause the arithmetic unit 400 to perform an intersection operation on the ray data and the block data.

It should be noted that the scheduler 300 may be communicatively connected to the first memory 100 and the second memory 200 in any suitable manner, and the arithmetic unit 400 may be communicatively connected to the first memory 100 and the second memory 200 in any suitable manner, which is not limited in the embodiments of the present disclosure. For example, the communication connection may include, but is not limited to, a communicative connection based on at least one of a bus, an interface, a shared storage space, and the like.

Based on the foregoing embodiments, the embodiments of the present disclosure provide a device for data scheduling based on ray tracing. The device includes portions and sub-portions in each portion, which may be implemented by a processor in a computer device, and may also be implemented by a specific logic circuit in actual applications. In implementation, the processor may be a central processing unit (CPU), a microprocessor unit (MPU), a digital signal processor (DSP), a field programmable gate array (FPGA), or the like.

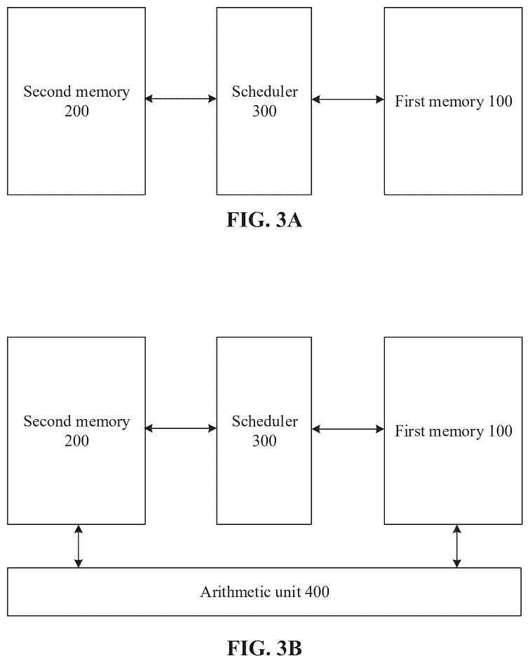

FIG. 4 is a schematic diagram of a composition structure of a device for data scheduling based on ray tracing according to an embodiment of the present disclosure. As shown in FIG. 4, the device 500 for data scheduling based on ray tracing includes a first determining portion 510, a first reading portion 520, and a second reading portion 530.

The first determining portion 510 is configured to determine a first target memory block in a first memory and a target memory block group in a second memory. Ray data and block data having a correspondence relationship are stored respectively in the first target memory block and the target memory block group.

The first reading portion 520 is configured to read the ray data from the first target memory block.

The second reading portion 530 is configured to read the block data from the target memory block group in two scheduling cycles. A write-priority mode and a read-priority mode are respectively used to perform data read scheduling in the first scheduling cycle and the second scheduling cycle of the two scheduling cycles.

In some embodiments, the first reading portion is further configured to read the ray data from the first target memory block into an arithmetic unit. The second reading portion is further configured to read the block data from the target memory block group into the arithmetic unit in two scheduling cycles, to cause the arithmetic unit to perform an intersection operation on the ray data and the block data.

In some embodiments, the block data is stored in a second target address of the target memory block group, the second target address corresponds to multiple memory blocks in the target memory block group, and the block data includes at least one of first sub-data and second sub-data. The second reading portion is further configured to: in case where there is at least one second target memory block to which no data is being written among a plurality of memory blocks corresponding to the second target address, read the first sub-data from the at least one second target memory block in the first scheduling cycle; and in case where there is at least one third target memory block other than the second target memory block among the plurality of memory blocks corresponding to the second target address, read-lock the at least one third target memory block and read the second sub-data from the at least one third target memory block in the second scheduling cycle.

In some embodiments, the second reading portion is further configured to: in case where the fourth target memory block in the target memory block group has a data writing request and the fourth target memory block is not read-locked, write data to the fourth target memory block in the second scheduling cycle.

In some embodiments, the first determining portion is further configured to determine at least one pair of candidate memory block and candidate memory block group from a plurality of memory blocks in the first memory and a plurality of memory block groups in the second memory. The ray data and the block data having a correspondence relationship are stored respectively in each pair of candidate memory block and candidate memory block group. The first determining portion is further configured to determine the target memory block group from the candidate memory block groups based on the number of readable memory blocks in each of the candidate memory block groups, and determine a candidate memory block corresponding to the target memory block group as the first target memory block.

In some embodiments, the first determining portion is further configured to determine the number of readable memory blocks in each of the candidate memory block groups. A read-write state of the readable memory block is a readable state. The first determining portion is further configured to determine a memory block group having the largest number of readable memory blocks among the candidate memory block groups as the target memory block group.

In some embodiments, the device further includes an acquiring portion configured to acquire a write-lock state and a read-lock state of each memory block in the candidate memory block group. The write-lock state includes one of a first state characterizing that data is being written to the memory block, and a second state characterizing that no data is being written to the memory block, and the read-lock state includes one of a third state characterizing that the memory block is read-locked, and a fourth state characterizing that the memory block is not read-locked. A second determining portion is configured to, for each of the memory blocks, determine the read-write state of the memory block to be a readable state in case where the write-locked state of the memory block is the second state and the read-locked state of the memory block is the fourth state.

In some embodiments, the first determining portion is further configured to: determine a first memory block group having the largest number of readable memory blocks among the candidate memory block groups; and in case where there are multiple first memory block groups, select one first memory block group from the first memory block groups as the target memory block group according to a preset selection manner.

In some embodiments, the first determining portion is further configured to: determine at least one pair of candidate memory block and candidate memory block group, a first target address corresponding to the candidate memory block and a second target address corresponding to the candidate memory block group in each pair of candidate memory block and candidate memory block group according to the plurality of memory blocks in the first memory and the plurality of memory block groups in the second memory. For each pair of candidate memory block and candidate memory block group, the ray data and the block data having a correspondence relationship are stored respectively in the first target address of the candidate memory block and the second target address of the candidate memory block group.

In the embodiments of the present disclosure and other embodiments, the “portion” may be a circuit portion, a processor portion, a program or software portion, or the like, and may also be a unit, a module or a non-modular one in actual applications.

The above description of the device embodiment is similar to the above description of the method embodiment, and has similar beneficial effects as the method embodiment. In some embodiments, the functions or modules included in the device provided by the embodiments of the present disclosure may be used to perform the methods described in the above-described method embodiments. For technical details not disclosed in the device embodiments of the present disclosure, reference may be made to the description in the method embodiments of the present disclosure for understanding.

In the embodiment of the present disclosure, if the above-described method is implemented in the software function modules and sold or used as an independent product, the software function modules may be stored in a computer-readable storage medium. Based on this understanding, the technical solution of the present disclosure essentially or a part of the technical solution that contributes to the prior art may be embodied in the form of a software product, the software product is stored in a storage medium, and includes several instructions for causing a computer device (which may be a personal computer, server, or network device, etc.) to perform all or a part of the method described in various embodiments of the present disclosure. The storage medium includes a USB disk, a removable hard disk, a Read-Only Memory (ROM), a magnetic disk or an optical disk or various mediums that can store a program code. Thus, the embodiments of the present disclosure are not limited to any specific hardware, software or firmware or any combination of the hardware, software or firmware.

The embodiments of the present disclosure provide a computer device including a processor and a memory. The memory is configured for storing a computer program which is able to run on the processor. The program, when executed by the processor, implements some or all of the operations of the above-described method.

The embodiments of the present disclosure provide a computer-readable storage medium on which a computer program is stored. The computer program is executed by a processor to implement some or all of the operations of the above-described method. The computer-readable storage medium may be a tangible device that holds and stores instructions used by an instruction execution device, may be a volatile storage medium or a non-volatile storage medium, and may be transient or non-transient.

The embodiments of the present disclosure provide a computer program comprising a computer-readable code. When the computer-readable code is executed in the computer device, a processor in the computer device executes some or all of the operations for implementing the above-described method.

The embodiments of the present disclosure provide a computer program product comprising a non-transitory computer-readable storage medium having a computer program stored thereon. The computer program, when read and executed by a computer, implements some or all of the operations of the above method. The computer program product may be implemented by means of hardware, software, or a combination thereof. In some embodiments, the computer program product is embodied as a computer storage medium, and in other embodiments, the computer program product is embodied as a software product, such as a software development kit (SDK) or the like.

The embodiments of the present disclosure provide a computer program product including a computer program or instruction that, when executed by a processor, implements some or all of the operations of the above method.

It should be pointed out here that the above description for the various embodiments emphasizes a difference of the embodiments, and regarding the similarities or commonalities thereof, reference may be made to each other. The device, the storage medium, the computer program, and the computer program product embodiments are described similarly to the description of the above method embodiments, and have similar beneficial effects as the method embodiments. Technical details not disclosed in the embodiments of the device, the storage medium, the computer program, and the computer program product of the present disclosure are understood with reference to the description in the method embodiments of the present disclosure.

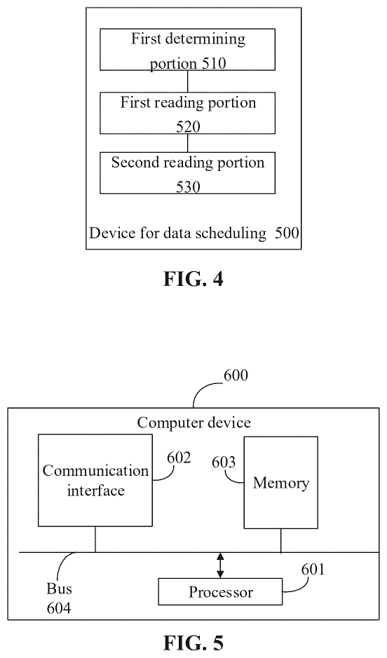

FIG. 5 is a schematic diagram of a hardware entity of a computer device according to an embodiment of the present disclosure. As shown in FIG. 5, the hardware entity of the computer device 600 includes a processor 601, a communication interface 602, and a memory 603.

The processor 601 generally controls an overall operation of the computer device 600.

The communication interface 602 may enable the computer device to communicate with another terminal or server over a network.

The memory 603 is configured to store instructions and applications executable by the processor 601, and may also store data (e.g., image data, audio data, voice communication data, and video communication data) to be processed or already processed by the processor 601 and various modules in the computer device 600, and the memory may be implemented by a FLASH or a random access memory (RAM). Data transmission between the processor 601, the communication interface 602, and the memory 603 may be performed through the bus 604.

It is to be understood that references “an embodiment” or “one embodiment” throughout the specification mean that a particular feature, structure, or characteristic related to the embodiment is included in at least one embodiment of the present disclosure. Accordingly, the references “in an embodiment” or “in one embodiment” that appear throughout the specification do not necessarily refer to the same embodiment. Furthermore, these particular features, structures, or characteristics may be incorporated into one or more embodiments in any suitable manner. It should be understood that in various embodiments of the present disclosure, the sequence numbers of the above-described operations/processes do not mean the order of execution, and the order of execution of each operation/process should be determined by its function and internal logic, and should not constitute any limitation on the implementation process of the embodiments of the present disclosure. The above-described sequence numbers of the embodiments of the present disclosure are for description only, and do not represent the advantages and disadvantages of the embodiments.

It should be noted that, the terms “comprise”, “include”, or any other variation thereof herein are intended to encompass a non-exclusive inclusion such that a process, a method, an article, or a device including a series of elements includes not only those elements, but also other elements that are not explicitly listed, or includes elements inherent to such the process, the method, the article, or the device. Without further limitation, an element defined by the statement “comprising a . . . ” does not preclude the presence of additional identical elements in the process, the method, the article, or the device that includes the elements.

In several embodiments provided by the present disclosure, it should be understood that the disclosed device and method may be implemented in other ways. The device embodiments described above are merely schematic. For example, the division of units is only a logical function division. In actual implementation, there may be other division methods. For example, multiple units or components may be combined, or may be integrated into another system, or some features may be ignored, or may not be implemented. Additionally, the coupling, or the direct coupling, or the communicative connection of the components shown or discussed may be indirect coupling or communication connection through some interfaces, devices or units, and may be electrical, mechanical, or otherwise.

The units described above as separate components may or may not be physically separated, and the components displayed as units may or may not be physical units. The components displayed as units may be located in one place or distributed to multiple network elements. Some or all of the units may be selected according to actual needs to achieve the purpose of the present embodiment solution. In addition, in each embodiment of the present disclosure, the functional units may be all integrated into one processing unit, each unit may be separately used as one unit, or two or more units may be integrated into one unit. The above integrated unit may be implemented either in the form of hardware or in the form of a combination of hardware and software functional units.

Those skilled in the art will understand that all or part of the operations for implementing the above-described method embodiments may be completed by hardware related to program instructions, and the aforementioned program may be stored in a computer-readable storage medium, and when the program is executed, the program implements the operations including the above-described method embodiments. The aforementioned storage medium includes various media capable of storing program codes, such as a removable storage device, a read only memory (ROM), a magnetic disk, an optical disk, or the like.

Alternatively, if the integrated unit of the present disclosure is implemented in the form of a software function module and sold or used as an independent product, the integrated unit may be stored in a computer-readable storage medium. Based on such understanding, the technical solution of the present disclosure essentially or a part of the technical solution that contributes to the prior art may be embodied in the form of a software product, the computer software product is stored in a storage medium, and includes several instructions for causing a computer device (which may be a personal computer, server, or network device, etc.) to perform all or a part of the method described in various embodiments of the present disclosure. The aforementioned storage medium includes various media capable of storing program codes, such as a removable storage device, a ROM, a magnetic disk, an optical disk, or the like.

The above description is merely the embodiments of the present disclosure, but the scope of protection of the present disclosure is not limited thereto, and any changes or substitutions that may be easily conceived by those skilled in the art within the technical scope of the present disclosure should be covered within the scope of protection of the present disclosure.

### INDUSTRIAL PRACTICALITY

The embodiments of the present disclosure provide a method, device and system for data scheduling based on ray tracing, a device, a storage medium, and a computer program product. The method for data scheduling based on ray tracing includes operations as follows. A first target memory block in a first memory and a target memory block group in a second memory are determined. Ray data and block data having a correspondence relationship are stored respectively in the first target memory block and the target memory block group. The ray data is read from the first target memory block, and the block data is read from the target memory block group in two scheduling cycles. A write-priority mode and a read-priority mode are respectively used to perform data read scheduling in the first scheduling cycle and the second scheduling cycle of the two scheduling cycles. According to the embodiments of the present disclosure, read scheduling efficiency of block data can be improved.

1. A method for data scheduling based on ray tracing, comprising:
determining a first target memory block in a first memory and a target memory block group in a second memory, wherein ray data and block data which have a correspondence relationship are stored respectively in the first target memory block and the target memory block group;
reading the ray data from the first target memory block; and
reading the block data from the target memory block group in two scheduling cycles, wherein a write-priority mode and a read-priority mode are respectively used to perform data read scheduling in a first scheduling cycle and a second scheduling cycle of the two scheduling cycles.

2. The method for data scheduling of claim 1, wherein the reading the ray data from the first target memory block comprises:
reading the ray data from the first target memory block into an arithmetic unit;
wherein the reading the block data from the target memory block group in two scheduling cycles comprises:
reading the block data from the target memory block group into the arithmetic unit in two scheduling cycles, to cause the arithmetic unit to perform an intersection operation on the ray data and the block data.

3. The method for data scheduling of claim 1, wherein the block data is stored in a second target address of the target memory block group, the second target address corresponds to a plurality of memory blocks in the target memory block group, and the block data comprises at least one of first sub-data or second sub-data;
wherein the reading the block data from the target memory block group in two scheduling cycles comprises:
in the first scheduling cycle, reading the first sub-data from at least one second target memory block in case where there is the at least one second target memory block to which no data is being written among a plurality of memory blocks corresponding to the second target address; and
in the second scheduling cycle, read-locking at least one third target memory block and reading the second sub-data from the at least one third target memory block in case where there is the at least one third target memory block other than the second target memory block among the plurality of memory blocks corresponding to the second target address.

4. The method for data scheduling of claim 3, wherein the reading the block data from the target memory block group in two scheduling cycles further comprises:
in the second scheduling cycle, writing data into a fourth target memory block in case where the fourth target memory block in the target memory block group has a data writing request and the fourth target memory block is not read-locked.

5. The method for data scheduling of claim 1, wherein the determining the first target memory block in the first memory and the target memory block group in the second memory comprises:
determining at least one pair of candidate memory block and candidate memory block group from a plurality of memory blocks in the first memory and a plurality of memory block groups in the second memory, wherein the ray data and the block data having a correspondence relationship are stored respectively in each pair of candidate memory block and candidate memory block group;
determining the target memory block group from candidate memory block groups based on a number of readable memory blocks in each of the candidate memory block groups; and
determining a candidate memory block corresponding to the target memory block group as the first target memory block.

6. The method for data scheduling of claim 5, wherein the determining the target memory block group from candidate memory block groups based on the number of readable memory blocks in each of the candidate memory block groups comprises:
determining the number of readable memory blocks in each of the candidate memory block groups, wherein a read-write state of the readable memory block is a readable state; and
determining a memory block group having a largest number of readable memory blocks among the candidate memory block groups as the target memory block group.

7. The method for data scheduling of claim 6, further comprising:
acquiring a write-lock state and a read-lock state of each memory block in the candidate memory block groups, wherein the write-lock state comprises one of a first state characterizing that data is being written to the memory block and a second state characterizing that no data is being written in the memory block, and the read-lock state comprises one of a third state characterizing that the memory block is read-locked and a fourth state characterizing that the memory block is not read-locked; and
for each memory block, determining the read-write state of the memory block to be the readable state in case where the write-lock state of the memory block is the second state and the read-lock state of the memory block is the fourth state.

8. The method for data scheduling of claim 5, wherein the determining the target memory block group from candidate memory block groups based on the number of readable memory blocks in each of the candidate memory block groups comprises:
determining one or more first memory block groups having a largest number of readable memory blocks among the candidate memory block groups; and
selecting one first memory block group from a plurality of first memory block groups as the target memory block group according to a preset selection manner in case where there are the plurality of first memory block groups.

9. The method for data scheduling of claim 5, wherein the determining at least one pair of candidate memory block and candidate memory block group from the plurality of memory blocks in the first memory and the plurality of memory block groups in the second memory comprises:
determining, from the plurality of memory blocks in the first memory and the plurality of memory block groups in the second memory, at least one pair of candidate memory block and candidate memory block group, a first target address corresponding to the candidate memory block and a second target address corresponding to the candidate memory block group in each pair of candidate memory block and candidate memory block group, wherein for each pair of candidate memory block and candidate memory block group, the ray data and the block data having a correspondence relationship are stored respectively in the first target address of the candidate memory block and the second target address of the candidate memory block group.

10. (canceled)

11. A system for data scheduling based on ray tracing, comprising:
a first memory configured for storing ray data;
a second memory configured for storing block data; and
a scheduler communicatively connected to the first memory and the second memory, and configured to:
determine a first target memory block in a first memory and a target memory block group in a second memory, wherein ray data and block data which have a correspondence relationship are stored respectively in the first target memory block and the target memory block group;
read the ray data from the first target memory block; and
read the block data from the target memory block group in two scheduling cycles, wherein a write-priority mode and a read-priority mode are respectively used to perform data read scheduling in a first scheduling cycle and a second scheduling cycle of the two scheduling cycles.

12. A non-transitory computer device comprising a processor and a memory having a computer program executable on the processor stored thereon, wherein the computer program, when executed by the processor, implements:
determining a first target memory block in a first memory and a target memory block group in a second memory, wherein ray data and block data which have a correspondence relationship are stored respectively in the first target memory block and the target memory block group;
reading the ray data from the first target memory block; and
reading the block data from the target memory block group in two scheduling cycles, wherein a write-priority mode and a read-priority mode are respectively used to perform data read scheduling in a first scheduling cycle and a second scheduling cycle of the two scheduling cycles.

13. (canceled)

14. (canceled)

15. The non-transitory computer device of claim 12, wherein the computer program, when executed by the processor, implements:
reading the ray data from the first target memory block into an arithmetic unit; and
reading the block data from the target memory block group into the arithmetic unit in two scheduling cycles, to cause the arithmetic unit to perform an intersection operation on the ray data and the block data.

16. The system for data scheduling of claim 11, wherein the scheduler is configured to:
read the ray data from the first target memory block into an arithmetic unit; and
read the block data from the target memory block group into the arithmetic unit in two scheduling cycles, to cause the arithmetic unit to perform an intersection operation on the ray data and the block data.

17. The system for data scheduling of claim 11, wherein the block data is stored in a second target address of the target memory block group, the second target address corresponds to a plurality of memory blocks in the target memory block group, and the block data comprises at least one of first sub-data or second sub-data;
wherein the scheduler is configured to:
in the first scheduling cycle, read the first sub-data from at least one second target memory block in case where there is the at least one second target memory block to which no data is being written among a plurality of memory blocks corresponding to the second target address; and
in the second scheduling cycle, read-lock at least one third target memory block and read the second sub-data from the at least one third target memory block in case where there is the at least one third target memory block other than the second target memory block among the plurality of memory blocks corresponding to the second target address.

18. The system for data scheduling of claim 17, wherein the scheduler is configured to:
in the second scheduling cycle, write data into a fourth target memory block in case where the fourth target memory block in the target memory block group has a data writing request and the fourth target memory block is not read-locked.

19. The system for data scheduling of claim 11, wherein the scheduler is configured to:
determine at least one pair of candidate memory block and candidate memory block group from a plurality of memory blocks in the first memory and a plurality of memory block groups in the second memory, wherein the ray data and the block data having a correspondence relationship are stored respectively in each pair of candidate memory block and candidate memory block group;
determine the target memory block group from candidate memory block groups based on a number of readable memory blocks in each of the candidate memory block groups; and
determine a candidate memory block corresponding to the target memory block group as the first target memory block.

20. The system for data scheduling of claim 19, wherein the scheduler is configured to:
determine the number of readable memory blocks in each of the candidate memory block groups, wherein a read-write state of the readable memory block is a readable state; and
determine a memory block group having a largest number of readable memory blocks among the candidate memory block groups as the target memory block group.

21. The system for data scheduling of claim 20, wherein the scheduler is configured to:
acquire a write-lock state and a read-lock state of each memory block in the candidate memory block groups, wherein the write-lock state comprises one of a first state characterizing that data is being written to the memory block and a second state characterizing that no data is being written in the memory block, and the read-lock state comprises one of a third state characterizing that the memory block is read-locked and a fourth state characterizing that the memory block is not read-locked; and
for each memory block, determine the read-write state of the memory block to be the readable state in case where the write-lock state of the memory block is the second state and the read-lock state of the memory block is the fourth state.

22. The system for data scheduling of claim 19, wherein the scheduler is configured to:
determine one or more first memory block groups having a largest number of readable memory blocks among the candidate memory block groups; and
select one first memory block group from a plurality of first memory block groups as the target memory block group according to a preset selection manner in case where there are the plurality of first memory block groups.

23. The system for data scheduling of claim 19, wherein the scheduler is configured to:
determine, from the plurality of memory blocks in the first memory and the plurality of memory block groups in the second memory, at least one pair of candidate memory block and candidate memory block group, a first target address corresponding to the candidate memory block and a second target address corresponding to the candidate memory block group in each pair of candidate memory block and candidate memory block group, wherein for each pair of candidate memory block and candidate memory block group, the ray data and the block data having a correspondence relationship are stored respectively in the first target address of the candidate memory block and the second target address of the candidate memory block group.
